(19) United States
(12) Patent Application Publication
(10) Pub. No.: US 2012/0307054 A1
(43) Pub. Date: Dec. 6, 2012

(54) VIDEO DEVICE

(75) Inventor: Kanji Imanishi, Osaka (JP)

(73) Assignee: FUNAI ELECTRIC CO., LTD.

(21) Appl. No.: 13/471,657

(22) Filed: May 15, 2012

(30) Foreign Application Priority Data
May 31, 2011 (JP) 2011-121697

(51) Int. Cl. H04N 7/18

(52) U.S. Cl. 348/143

(57) ABSTRACT

A video device for receiving capture image data from a server and displaying video based on the received capture image data or causing video based on the received capture image data to be displayed by a display device is provided with a network interface for connecting to a LAN, and a discovery unit for searching for the server within the LAN and discovering the server within the LAN. In a case in which the server discovered by the discovery unit is a plurality, the video device acquires capture image data from each of the plurality of servers and performs a thumbnail display of an acquired capture image from each of the plurality of servers or causes a thumbnail display of an acquired capture image from each of the plurality of servers to be performed by the display device.

This nonprovisional application claims priority under 35 U.S.C. §119(a) on Patent Application No. 2011-121697 filed in Japan on May 31, 2011, the entire contents of which are hereby incorporated by reference.

### BACKGROUND OF THE INVENTION

1. Field of the Invention

The present invention relates to a video device for displaying video or causing video to be displayed by a display device, and relates particularly to a video device which has network connectivity. A video device for displaying video may be a television receiver or the like, for example, and a video device for causing video to be displayed by a display device may be an optical disk device, a hard disk device, a multifunction machine having an optical disk device and a hard disk device, or the like, for example.

2. Description of Related Art

Video devices having network connectivity have recently become widespread. Video devices having network connectivity are usually configured to play back content that is provided from a network-connected server (see, for example, Japanese Laid-open Patent Publication Nos. 2008-131231, 2005-191802, and 2005-78164). A video device thus configured must be able to support a variety of formats in order to be able to play back content that is in various formats.

A technique has also become common in which a server transmits, to a video device through a network, capture image data obtained by capturing a display screen of the server, and the video device displays video based on the received capture image data, or causes video based on the received capture image data to be displayed by a display device (as in Philips MediaConnect (registered trademark), for example). This technique is advantageous because the video device need only be capable of processing the received capture image data, and therefore need not be configured in advance to support various formats.

In order to implement the technique described above, MediaConnect application software for using the capture image data is installed in the server, and the video device has a MediaConnect function for using the capture image data.

The operation of a standard video device having a MediaConnect function for using capture image data shall now be described with reference to FIG. 6. When the MediaConnect function for using capture image data is started by a user operation, the standard video device starts the flow of operations shown in FIG. 6.

First, the standard video device initiates a search to determine whether a server (MediaConnect server) that has the MediaConnect application software using the capture image data installed therein and that is running the application software is present in a LAN (Local Area Network) to which the standard video device is connected (step S101). The standard video device then determines whether a MediaConnect server has been discovered (step S102).

When a MediaConnect server is discovered (step S102: YES), the standard video device receives the capture image data from the discovered MediaConnect server and displays video based on the received capture image data, or causes video based on the received capture image data to be displayed by a display device (step S103). In step S104 following step S103, the standard video device determines whether an instruction to terminate the MediaConnect function for using the capture image data has been issued by a user operation. When no instruction has been issued to terminate the MediaConnect function for using the capture image data (step S104: NO), the process returns to step S103. When an instruction has been issued to terminate the MediaConnect function for using the capture image data (step S104: YES), the flow of operations shown in FIG. 6 is ended.

When a MediaConnect server is not discovered (step S102: NO), the standard video device determines whether a predetermined time has elapsed since the start of searching (step S105), and when the predetermined time has not elapsed since the start of searching (step S105: NO), the process returns to step S102. When the predetermined time has elapsed since the start of searching (step S105: YES), the flow of operations shown in FIG. 6 is ended.

In the case in which a plurality of MediaConnect servers is present in the LAN to which the standard video device is connected, the standard video device receives the capture image data from the MediaConnect server that was first to be discovered.

Therefore, in the case that the MediaConnect server that was first to be discovered by the standard video device is not the desired MediaConnect server, the necessary response is either for the MediaConnect function for using the capture image data to be repeatedly restarted until the MediaConnect server first to be discovered by the standard video device becomes the desired MediaConnect server, or for the MediaConnect function for using the capture image data to be restarted once the MediaConnect server other than the desired MediaConnect server has been removed from the LAN. Both of these responses are inconvenient.

### SUMMARY OF THE INVENTION

An object of the present invention is to provide a video device for receiving capture image data from a server and displaying video based on the received capture image data or causing video based on the received capture image data to be displayed by a display device, wherein the desired server can easily be selected when a plurality of servers is present in a LAN to which the video device is connected.

The video device according to the present invention for achieving the abovementioned objects is a video device for receiving capture image data from a server and displaying video based on the received capture image data or causing video based on the received capture image data to be displayed by a display device, the video device comprising:

a network interface for connecting to a LAN; and

a discovery unit for searching for the server within the LAN and discovering the server within the LAN; wherein

in a case in which the server discovered by the discovery unit is a plurality, the video device acquires capture image data from each of the plurality of servers and performs a thumbnail display of an acquired capture image from each of the plurality of servers or causes a thumbnail display of an acquired capture image from each of the plurality of servers to be performed by the display device.

Through such a configuration, a user can ascertain which server is the desired server, and can easily select the desired server.

A configuration may be adopted in which the video device receives capture image data from the server selected through use of the thumbnail display and displays video based on the received capture image data or causes video based on the received capture image data to be displayed by a display device.

Through such a configuration, since the desired server can be selected using the thumbnail display, the operation performed by the user to select the desired server is simplified.

A configuration may be adopted in which, in a case in which the server discovered by the discovery unit is a plurality, the video device acquires a capture image from each of the plurality of servers, as well as an IP address of each of the plurality of servers, and displays the IP address of each of the plurality of servers as well in the thumbnail display or causes the IP address of each of the plurality of servers to also be displayed by the display device in the thumbnail display.

Through such a configuration, the user can ascertain which server is the desired server more easily than in a case in which IP addresses are not displayed.

A configuration may be adopted in which the video device immediately performs the thumbnail display or causes the thumbnail display to be performed by the display device when the number of servers discovered by the discovery unit reaches two.

Through such a configuration, the user can be prevented from experiencing long wait times when a plurality of servers is present in the LAN.

### BRIEF DESCRIPTION OF THE DRAWINGS

FIG. 1 is a view showing the general configuration of an optical disk recording/playback device according to an embodiment of the present invention;

FIG. 2 is a flowchart showing the operation of the optical disk recording/playback device according to an embodiment of the present invention;

FIG. 3 is a view showing an example of a thumbnail screen;

FIG. 4 is a view showing another example of a thumbnail screen;

FIG. 5 is a flowchart showing other operations of the optical disk recording/playback device according to an embodiment of the present invention; and

FIG. 6 is a flowchart showing the operation of a standard video device having a MediaConnect function for using capture image data.

### DETAILED DESCRIPTION OF PREFERRED EMBODIMENTS

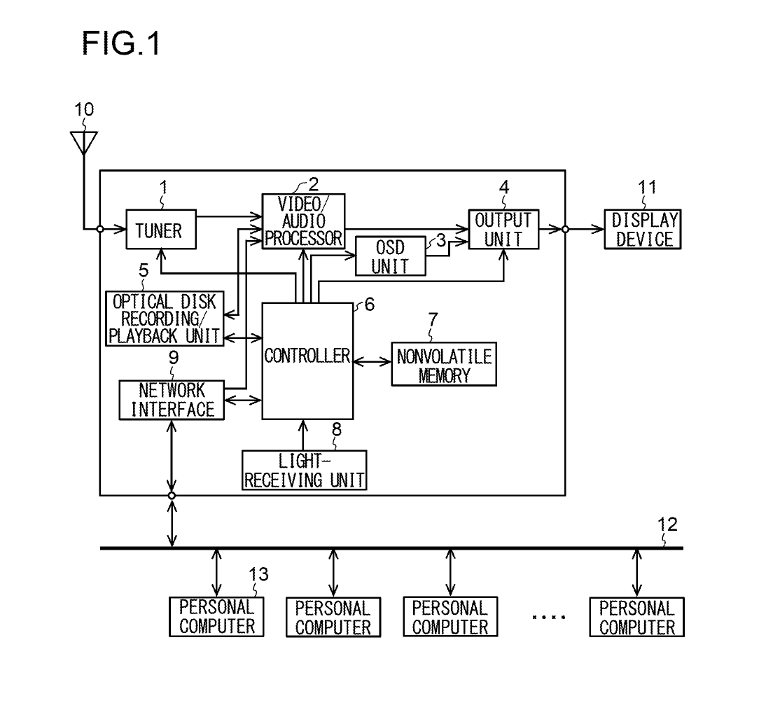

Embodiments of the present invention will be described with reference to the accompanying drawings. FIG. 1 shows the general configuration of an optical disk recording/playback device according to an embodiment of the present invention.

The optical disk recording/playback device according to an embodiment of the present invention is a video device having a MediaConnect function for using capture image data, and is provided with a tuner 1, a video/audio processor 2, an OSD (On Screen Display) unit 3, an output unit 4, an optical disk recording/playback unit 5, a controller 6, a nonvolatile memory 7, a light-receiving unit 8, and a network interface 9. The controller 6 corresponds to the “discovery unit” recited in the claims. A CPU (Central Processing Unit) may be used as the controller 6.

The tuner 1 performs channel selection and demodulation (e.g., OFDM (Orthogonal Frequency Division Multiplexing) demodulation) of a television broadcast signal received from an antenna 10. The video/audio processor 2 performs functions such as sending a video/audio signal received from the tuner 1 or a video/audio signal reproduced by the optical disk recording/playback unit 5 to the output unit 4, sending a video/audio signal received from the tuner 1 to the optical disk recording/playback unit 5, and processing capture image data received by the network interface 9 and sending the processed capture image data to the output unit 4. The OSD unit 3 sends, to the output unit 4, OSD image data generated on the basis of an instruction from the controller 6. The output unit 4 performs functions such as outputting, to the outside, a composite video signal in which a video signal received from the video/audio processor 2 and OSD image data received from the OSD unit 3 are combined; outputting, to the outside and without modification, the video signal received from the video/audio processor 2 without performing the synthesis processing described above; outputting, to the outside and without modification, the OSD image data received from the OSD unit 3 without performing the synthesis processing described above; and outputting an audio signal received from the video/audio processor 2 to the outside. A display device (e.g., television receiver) 11 connected to the optical disk recording/playback device according to an embodiment of the present invention performs video display and audio output which are based on the output signal of the output unit 4.

The optical disk recording/playback unit 5 performs functions such as recording, on an optical disk, a video/audio signal received from the video/audio processor 2, and reproducing video/audio signals recorded on an optical disk. The optical disk is removably loaded in the optical disk recording/playback unit 5.

The light-receiving unit 8 receives a remote control infrared signal transmitted from a remote control transmitter (not shown) and converts the infrared signal to an electrical signal, and extracts an operation code from the electrical signal and outputs the operation code to the controller 6. The controller 6 controls components of the optical disk recording/playback device according to an embodiment of the present invention in accordance with a control program and various settings (e.g., a data table or the like for associating operation codes and functions) stored in the nonvolatile memory 7, operation codes received from the light-receiving unit 8, and operation codes determined by signals outputted from an operating key group (not shown) provided to the main body of the optical disk recording/playback device according to an embodiment of the present invention.

The network interface 9 is network-connected to a plurality of personal computers 13 by a LAN 12. Of the plurality of the personal computers 13, a personal computer that has the MediaConnect application software using the capture image data installed therein and that is running the application software functions as a MediaConnect server. The LAN 12 may be a wired LAN or a wireless LAN, or a combination of a wired LAN and a wireless LAN.

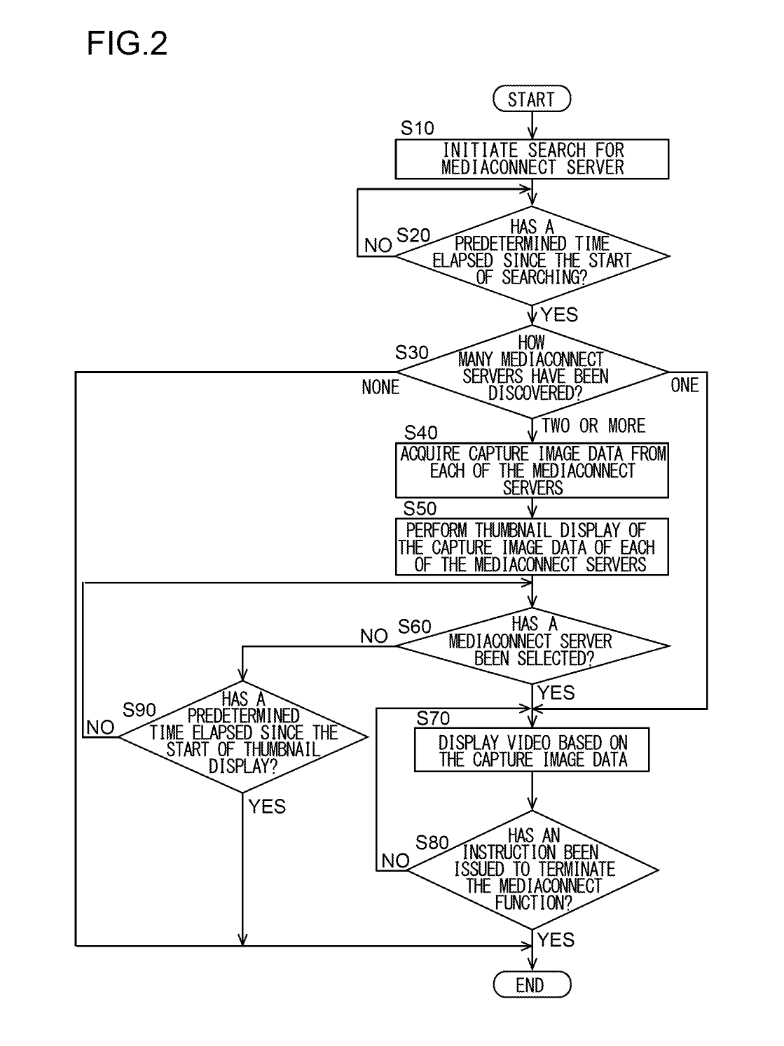

The operation of the optical disk recording/playback device according to an embodiment of the present invention will next be described with reference to FIG. 2. When the MediaConnect function using the capture image data is started by a user operation, the optical disk recording/playback device according to an embodiment of the present invention begins the flow of operations shown in FIG. 2.

First, the optical disk recording/playback device according to an embodiment of the present invention initiates a search to determine whether a MediaConnect server is present in the LAN 12 (step S10). The optical disk recording/playback device according to an embodiment of the present invention then determines whether a predetermined time has elapsed since the start of searching (step S20), and when the predetermined time has not elapsed since the start of searching (step S20: NO), the process returns to step S10. When the predetermined time has elapsed since the start of searching (step S20: YES), the number of discovered MediaConnect servers is confirmed (step S30). Specifically, in step S10, the optical disk recording/playback device according to an embodiment of the present invention discovers a MediaConnect server in the LAN 12 by transmitting a command for a MediaConnect server search and receiving a response from the MediaConnect server in response to the command. After issuing the abovementioned response to the optical disk recording/playback device according to an embodiment of the present invention, until the optical disk recording/playback device according to an embodiment of the present invention issues notification of ending of the MediaConnect function for using the capture image data, the MediaConnect server periodically captures a display screen of the MediaConnect server and transmits, via the network, capture image data obtained by the capture to the optical disk recording/playback device according to an embodiment of the present invention.

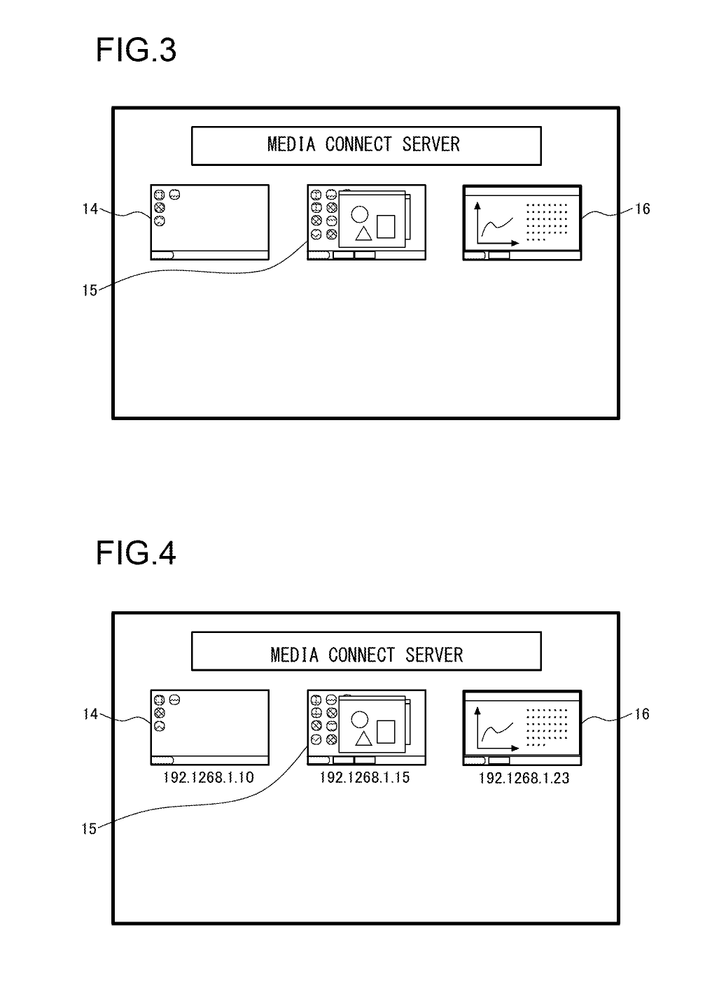

In the case that the results of the confirmation in step S30 show that there are two or more MediaConnect servers discovered, the optical disk recording/playback device according to an embodiment of the present invention acquires the capture image data from each of the MediaConnect servers (step S40) and causes a thumbnail display of the capture image of each of the MediaConnect servers to be performed by the display device 11 (step S50). In a case in which there are, for example, three MediaConnect servers, the optical disk recording/playback device according to an embodiment of the present invention causes thumbnail screens such as those shown in FIG. 3 to be displayed by the display device 11. The thumbnail image 14 is a thumbnail display of the capture image of the first MediaConnect server, the thumbnail image 15 is a thumbnail display of the capture image of the second MediaConnect server, and the thumbnail image 16 is a thumbnail display of the capture image of the third MediaConnect server. A configuration may be adopted in which capture image data from each of the MediaConnect servers as well as the IP address of each of the MediaConnect servers are acquired in step S40, and an IP address is additionally displayed in each of the thumbnail displays of step S50. In this case, a thumbnail screen such as the one shown in FIG. 4, for example, is produced.

In step S60 following step S50, the optical disk recording/playback device according to an embodiment of the present invention determines whether a MediaConnect server has been selected by a user operation (step S60). As to the method for selecting a MediaConnect server, in a thumbnail screen such as shown in FIG. 3 or FIG. 4, for example, the capture image of a selected MediaConnect server in the thumbnail display is highlighted, the highlight position is changed by operating a directional keypad of the remote control transmitter (not shown), and the selection of a MediaConnect server is confirmed by operating an enter key of the remote control transmitter (not shown).

Since each of the MediaConnect servers is assigned the same name in the MediaConnect function for using capture image data, in a case in which the server names are displayed in a list when a plurality of MediaConnect servers is discovered, it is impossible for the user to ascertain which MediaConnect server is the desired MediaConnect server, and the desired MediaConnect server cannot easily be selected. However, when a capture image of each MediaConnect server is shown in a thumbnail display by the display device 11 when a plurality of MediaConnect servers is discovered, as in the optical disk recording/playback device according to an embodiment of the present invention, the user can ascertain which MediaConnect server is the desired MediaConnect server, and the desired MediaConnect server can easily be selected. In the case that IP addresses are additionally displayed in the thumbnail display, the user can ascertain which MediaConnect server is the desired MediaConnect server more easily than in a case in which IP addresses are not displayed.

When a MediaConnect server is not selected (step S60: NO), the optical disk recording/playback device according to an embodiment of the present invention determines whether a predetermined time has elapsed since the start of the thumbnail display (step S90), and when the predetermined time has not elapsed since the start of the thumbnail display (step S90: NO), the process returns to step S60. When the predetermined time has elapsed since the start of the thumbnail display (step S90: YES), the flow of operations shown in FIG. 2 is ended.

When a MediaConnect server has been selected (step S60: YES), the optical disk recording/playback device according to an embodiment of the present invention receives capture image data from the selected MediaConnect server and causes video based on the received capture image data to be displayed by the display device 11 (step S70). In step S80 following step S70, the optical disk recording/playback device according to an embodiment of the present invention determines whether an instruction to terminate the MediaConnect function for using the capture image data has been issued by a user operation. When no instruction has been issued to terminate the MediaConnect function for using the capture image data (step S80: NO), the process returns to step S70. When an instruction has been issued to terminate the MediaConnect function for using the capture image data (step S80: YES), the flow of operations shown in FIG. 2 is ended.

In the case in which the results of the confirmation in step S30 show that there is one MediaConnect server discovered, the process immediately transitions to step S70, and the optical disk recording/playback device according to an embodiment of the present invention executes the processing of step S70 using the discovered MediaConnect server as the selected MediaConnect server. In the case that the results of confirmation in step S30 show that there are no MediaConnect servers discovered, the flow of operations shown in FIG. 2 is immediately ended. Consequently, when there is one or no MediaConnect server discovered, the optical disk recording/playback device according to an embodiment of the present invention performs the same operations as a standard video device having the MediaConnect function for using capture image data.

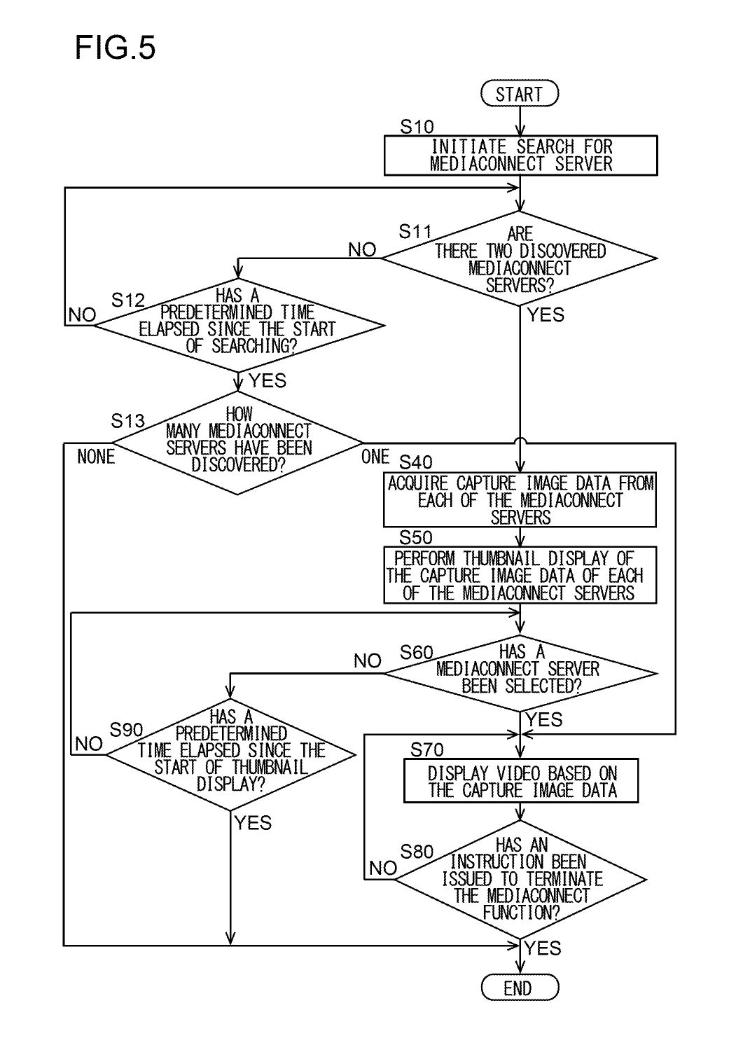

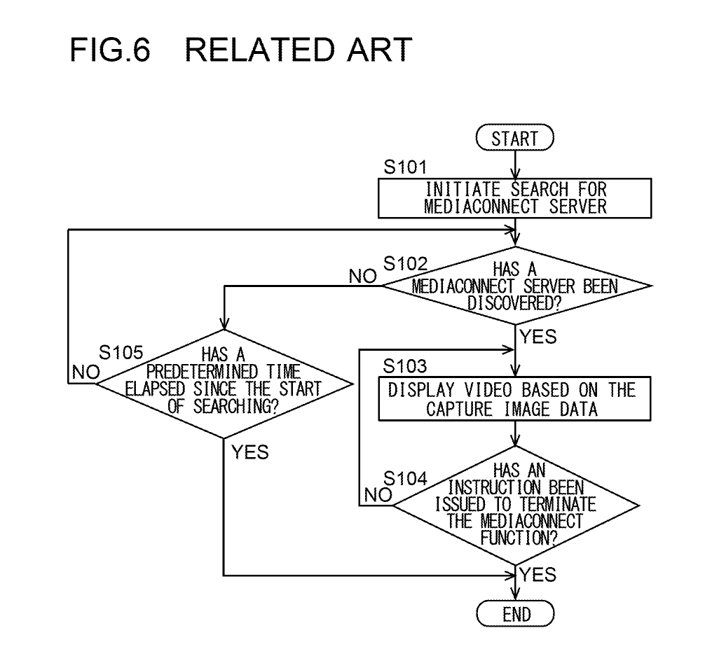

In the flow of operations shown in FIG. 2, in the case in which a plurality of MediaConnect servers is present in the LAN 12, since a thumbnail screen such as the one shown in FIG. 3 or FIG. 4 does not appear in the display device 11 until a predetermined time has elapsed from the start of searching to determine whether a MediaConnect server is present in the LAN 12, the user experiences a long wait time. A more preferred configuration is therefore obtained by changing the flow of operations shown in FIG. 2 to the flow of operations shown in FIG. 5.

The flow of operations shown in FIG. 5 is obtained from the flow of operations shown in FIG. 2 by omitting steps S20 and S30 and adding steps S11, S12, and S13.

In the flow of operations shown in FIG. 5, after step S10, the optical disk recording/playback device according to an embodiment of the present invention determines whether the number of discovered MediaConnect servers has reached two (step S11).

When the number of discovered MediaConnect servers has reached two (step S11: YES), the process immediately transitions to step S40, and then transitions to step S50. Through this configuration, when the number of discovered MediaConnect servers reaches two, a thumbnail screen having capture images for the two MediaConnect servers in thumbnail display promptly appears in the display device 11. After the transition to step S40 as well, the search for MediaConnect servers continues until the predetermined time has elapsed from the start of searching in step S10, and each time an additional MediaConnect server is discovered, the capture image in thumbnail display for the additionally discovered MediaConnect server is added to the thumbnail screen. The user can thereby be prevented from experiencing a long wait time when a plurality of MediaConnect servers is present in the LAN 12. The desired MediaConnect server can also be selected as soon as the capture image in thumbnail display for the desired MediaConnect server appears in the thumbnail screen, even before all of the MediaConnect servers have been discovered. It is therefore possible to reduce the time needed to select the desired MediaConnect server.

When the number of discovered MediaConnect servers has not reached two (step S11: NO), the optical disk recording/playback device according to an embodiment of the present invention determines whether the predetermined time has elapsed since the start of searching (step S12), and when the predetermined time has not elapsed since the start of searching (step S12: NO), the process returns to step S11. When the predetermined time has elapsed since the start of searching (step S12: YES), the number of discovered MediaConnect servers is confirmed (step S13). In the case in which the results of the confirmation in step S13 show that there is one MediaConnect server discovered, the process immediately transitions to step S70, and the optical disk recording/playback device according to an embodiment of the present invention executes the processing of step S70 using the discovered MediaConnect server as the selected MediaConnect server. In the case that the results of confirmation in step S13 show that there are no MediaConnect servers discovered, the flow of operations shown in FIG. 5 is immediately ended.

An embodiment of the present invention is described above, but the scope of the present invention is not limited by this embodiment, and various modifications to this embodiment are possible within the intended scope of the invention.

For example, an optical disk recording/playback device is described in the above embodiment as an example of the video device of the present invention, but the present invention can also be applied to a television receiver or the like.

What is claimed is:

1. A video device for receiving capture image data from a server and displaying video based on the received capture image data or causing video based on the received capture image data to be displayed by a display device, the video device comprising:
a network interface for connecting to a LAN; and
a discovery unit for searching for the server within the LAN and discovering the server within the LAN; wherein
in a case in which the server discovered by the discovery unit is a plurality, the video device acquires capture image data from each of the plurality of servers and performs a thumbnail display of an acquired capture image from each of the plurality of servers or causes a thumbnail display of an acquired capture image from each of the plurality of servers to be performed by the display device.

2. The video device according to claim 1, wherein
the video device receives capture image data from the server selected through use of the thumbnail display and displays video based on the received capture image data or causes video based on the received capture image data to be displayed by a display device.

3. The video device according to claim 1, wherein
in a case in which the server discovered by the discovery unit is a plurality, the video device acquires a capture image from each of the plurality of servers, as well as an IP address of each of the plurality of servers, and displays the IP address of each of the plurality of servers as well in the thumbnail display or causes the IP address of each of the plurality of servers to also be displayed by the display device in the thumbnail display.

4. The video device according to claim 2, wherein
in a case in which the server discovered by the discovery unit is a plurality, the video device acquires a capture image from each of the plurality of servers, as well as an IP address of each of the plurality of servers, and displays the IP address of each of the plurality of servers as well in the thumbnail display or causes the IP address of each of the plurality of servers to also be displayed by the display device in the thumbnail display.

5. The video device according to claim 1, wherein
the video device immediately performs the thumbnail display or causes the thumbnail display to be performed by the display device when the number of servers discovered by the discovery unit reaches two.

6. The video device according to claim 2, wherein
the video device immediately performs the thumbnail display or causes the thumbnail display to be performed by the display device when the number of servers discovered by the discovery unit reaches two.

7. The video device according to claim 3, wherein
the video device immediately performs the thumbnail display or causes the thumbnail display to be performed by the display device when the number of servers discovered by the discovery unit reaches two.

8. The video device according to claim 4, wherein
the video device immediately performs the thumbnail display or causes the thumbnail display to be performed by the display device when the number of servers discovered by the discovery unit reaches two.
